(19) United States
(12) Patent Application Publication
(10) Pub. No.: US 2024/0423229 A1
(43) Pub. Date: Dec. 26, 2024

(54) PLANT-BASED CHEESE PRODUCT

(71) Applicant: MASSEY VENTURES LIMITED, Palmerston North (NZ)

(72) Inventors: Debashree ROY, Palmerston North (NZ); Yiran WANG, Palmerston North (NZ); Arup NAG, Palmerston North (NZ); Alejandra ACEVEDO FANI, Palmerston North (NZ); Anant DAVE, Palmerston North (NZ); Harjinder SINGH, Palmerston North (NZ)

(21) Appl. No.: 18/684,157

(22) PCT Filed: Aug. 17, 2022
(86) PCT No.: PCT/IB2022/057687

§ 371 Date: Feb. 15, 2024

(30) Foreign Application Priority Data
Aug. 18, 2021 (AU) 2021902572

(51) Int. Cl. A23C 20/02; A23J 3/14; A23J 3/16; A23J 3/26; A23J 3/34

(52) U.S. Cl. CPC A23C 20/025; A23J 3/14; A23J 3/16; A23J 3/26; A23J 3/346

(57) ABSTRACT

The invention relates to a plant-based cheese product comprising about 5 wt % to about 40 wt % protein, and process for preparing said cheese product. The plant-based cheese product of the invention has similar textural and sensory properties to dairy cheese.

### 1. FIELD OF THE INVENTION

The invention relates generally to a plant-based cheese product and a process for preparing said cheese product.

### 2. BACKGROUND OF THE INVENTION

Cheeses are popular food products, enjoyed in many cultures for their nutritional value, culinary versatility and taste. However, consumer concerns such as saturated fats and hormones in cow milk, animal welfare issues and the detrimental environmental effects of dairying, have driven global demand for plant-based alternatives.

Unfortunately, non-dairy cheese alternatives struggle to simulate the taste, texture and nutritional value of dairy-based cheeses and therefore provide only a poor substitute in many circumstances.

The functionality of a cheese product is influenced by its micro- and macro-structures, which in turn are affected by the composition of the cheese product and processing conditions under which it is prepared. A cheese product may be required to exhibit functional attributes such as ease of spreading, crumbliness, sliceability and shreddability. When heated or cooked, a cheese product may be expected to demonstrate meltability, flowability, browning, oiling off and/or stretchability (Masotti et. al., 2018).

Unfortunately, substituting casein with vegetable proteins tends to result in a cheese product with impaired texture and functionality (Fox et al., 2017). Generally, substituting casein with greater than 20% vegetable proteins cause texture problems including lack of elasticity, reduced hardness, reduced meltability and low stretchability (Chavan & Jana, 2007; Guinee, 2016; Masotti et. al., 2018).

The functionality of dairy-based cheese can be matched to some extent in plant-based cheese products by including starches, gums and/or gelling agents to mimic dairy protein functionalities in terms of texture, flavour, hardness, meltability and stretchability etc.

However, the resulting products have a very low protein content making them nutritionally inferior to dairy-based cheeses, which normally have a protein content of about 15 to 30 wt %. In addition, despite the excipients mimicking protein functionalities, plant-based cheeses generally fall far short of meeting the textural and/or sensory properties expected by consumers used to genuine dairy cheese.

Accordingly, manufacturers are struggling to produce plant-based cheese products that have the requisite cheese-like functionalities in addition to a protein content comparable to standard dairy-based cheese.

It is therefore an object of the invention to provide a process for preparing a high protein plant-based cheese product that overcomes at least some of the disadvantages in the art as set out above and/or that provides the public with a useful choice.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

### 3. SUMMARY OF THE INVENTION

The inventors have developed a method for preparing a high protein plant-based cheese product with similar properties to dairy-based cheese.

In one aspect the invention provides a method for producing a plant-based cheese product comprising about 5 wt % to about 40 wt % protein, the method comprising:
(a) providing a composition comprising a source of plant protein and up to about 10 wt % lipid, relative to the source of plant protein;
   wherein the source of plant protein comprises:
   (i) at least about 5 wt % pea and/or soy protein, and
   (ii) at least about 40 wt % total protein;
(b) subjecting the composition to high moisture extrusion to form a semi-solid, texturized mass;
(c) shredding the extruded, texturized semi-solid mass to provide a granular material;
(d) mixing the granular material with lipid and incubating the granular material with one or more protease or protein cross-linking enzymes;
(e) treating the mixture formed in step (d) to inactivate the enzymes; and
(f) cooling the mixture formed in step (e) to provide the plant-based cheese product.

In one embodiment the source of the plant protein comprises at least about 6, 7, 8, 9 or 10 wt % pea and/or soy protein. In one embodiment the source of the plant protein comprises at least about 42, 44, 46, 68 or 50 wt % total protein. In one embodiment, the process provides a method for producing a plant-based cheese product comprising about 6, 7, 8, 9 or 10 wt % to about 40 wt % protein.

In another aspect the invention provides a plant-based cheese product produced by the method of the invention. In another aspect the invention provides a plant-based cheese product comprising about 5, 6, 7, 8, 9 or 10 wt % to about 40 wt % protein. In another aspect the invention provides a plant-based cheese product comprising about 10 to 40 wt % protein.

Various embodiments of the different aspects of the invention as discussed above are also set out below in the detailed description of the invention, but the invention is not limited thereto.

Other aspects of the invention may become apparent from the following description which is given by way of example only.

### 4. BRIEF DESCRIPTION OF THE FIGURES

FIG. 1 is a graph showing the change in storage modulus G′ (Pa) with temperature as the Riddet cheese product (Example 7) and Control cheese product (Example 8) are heated.

FIG. 2 is a graph showing the change in storage modulus G′ (Pa) with temperature as the Riddet cheese product (Example 7) and a range of commercial cheese products are heated.

FIG. 3 is a series of photographs showing A: Riddet cheese product (Example 7); B: Commercial dairy processed cheese slices; C: Vegan processed cheese slices (low to no protein).

### 5. DETAILED DESCRIPTION OF THE INVENTION

### 5.1 Definitions and Abbreviations

As used herein the term “comprising” means “consisting at least in part of”. When interpreting each statement in this specification that includes the term “comprising”, features other than that or those prefaced by the term may also be present. Related terms such as “comprise” and “comprises” are to be interpreted in the same manner. The term “about” as used herein means a reasonable amount of deviation of the modified term such that the end result is not significantly changed. For example, when applied to a value, the term should be construed as including a deviation of +/−10% of the value.

The term “melting cheese” as used herein refers to a type of cheese that melts when heated. Rennet-curdled cheeses have a gel-like protein matrix that is broken down by heat. When enough protein bonds are broken, the cheese turns from a solid to a viscous liquid. Soft, high-moisture cheeses will generally melt at around 55° C. (131° F.), while hard, low-moisture cheeses such as Parmesan often remain solid until they reach about 82° C. (180° F.). Examples of melting cheese include, but are not limited to, Cheddar, Gruyere, Provolone, Mozzarella, Parmesan, Fontina, Asiago, Taleggio.

The term “non-melting cheese” as used herein refers to a type of cheese that does not melt when heated. Acid-set cheeses, including halloumi, paneer, some whey cheeses and many varieties of fresh mammalian milk (goat, sheep, buffalo, yak etc.) cheeses, have a protein structure that remains intact at high temperatures. When cooked, these cheeses just get firmer as water evaporates. Examples of non-melting cheese include, but are not limited to Paneer, Feta, Mascarpone, Quark, Ricotta, Cottage cheese, Haloumi, some whey cheeses and many varieties of fresh mammalian milk cheeses.

The term “texturised” as used herein with reference to a plant-based cheese product, means that the product has been treated so as to change the globular amorphous particles of a mix of proteins from different sources into a concentrated mass containing cross-linked and fused protein molecules.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

Whenever a range is given in the specification, for example, a temperature range, a time range, or a composition range, all intermediate ranges and subranges, as well as all individual values included in the ranges given are intended to be included in the disclosure. In the disclosure and the claims, “and/or” means additionally or alternatively. Moreover, any use of a term in the singular also encompasses plural forms.

### 4.2 the Process of the Invention

In one aspect the invention provides a method for producing a plant-based cheese product comprising about 5 wt % to about 40 wt % protein, the method comprising:
(a) providing a composition comprising a source of plant protein and up to about 10 wt % lipid, relative to the source of plant protein;
   wherein the source of plant protein comprises:
      (i) at least about 5 wt % pea and/or soy protein, and
      (ii) at least about 40 wt % total protein;
(b) subjecting the composition to high moisture extrusion to form a semi-solid, texturized mass;
(c) shredding the extruded, texturized semi-solid mass to provide a granular material;
(d) mixing the granular material with lipid and incubating the granular material with one or more protease or protein cross-linking enzymes;
(e) treating the mixture formed in step (d) to inactivate the enzymes; and
(f) cooling the mixture formed in step (e) to provide the plant-based cheese product.

The process of the invention first combines a source of plant protein, and optionally a lipid, using high moisture extrusion.

In the process of the invention, at least about 5 wt % (on a dry basis) of the plant protein source comprises pea and/or soy protein. In one embodiment the source of the plant protein comprises at least about 6, 7, 8, 9 or 10 wt % pea and/or soy protein. The source of plant protein will typically also include other plant proteins. The source of plant protein may also comprise carbohydrates and/or lipids but must comprise at least about 40 wt % protein in total, on a dry basis. Therefore, if the plant protein source comprises 10 wt % pea protein and 5 wt % soy protein, it must also contain other plant protein such that the total protein content exceeds 40 wt % on a dry basis, preferably 50 wt %.

In one embodiment the plant protein is selected from the group comprising pea protein, fava protein, soy protein, mung bean protein, gluten protein, cashew protein, pumpkin seed protein, potato protein, chickpea protein, lentil protein, rice protein, corn protein, sunflower seed protein, tomato seed protein, pongamia protein, canola protein, peanut protein, almond protein, mushroom protein, quinoa protein, lupin protein, oat protein, amaranth protein, flaxseed protein, chia seed protein, cotton seed protein, buckwheat protein, sorghum protein, barley protein, water cress protein, pennycress protein, hemp seed protein, millet protein, teff protein, spelt protein, alfalfa protein, hazelnut protein, broad bean protein, adzuki bean protein, cannellini protein, grass protein, black bean protein, black gram protein, and mixtures thereof.

In one embodiment the source of plant protein (also referred to as the plant protein source) comprises a plant protein powder or mixture thereof. Plant protein powders include plant protein isolates, plant protein concentrates and plant protein flours. Plant protein isolates generally comprise about 80% protein while plant protein concentrates are lower in protein concentration (50-80%). Grain, legumes and lentil flours are lower in protein concentration, containing carbohydrates and oils in some cases.

The source of plant protein may comprise a mixture of protein isolates and/or concentrates combined with lower concentration plant protein flours, provided that the protein content of the source of plant protein is at least about 40 wt %, preferably about 50 wt %.

Non-powder sources of protein may also be included, such as undried protein extracts and concentrates, plant material slurries or even the original protein source; for example, lentils. The protein content of the plant protein source is always calculated on a dry basis.

In one embodiment the source of plant protein comprises one or more of a pea protein concentrate or isolate, fava protein concentrate or isolate, soy protein concentrate or isolate, mung bean protein concentrate or isolate, hemp protein concentrate, gluten protein concentrate or isolate, or a mixture thereof.

In one embodiment the source of plant protein comprises one or more of cashew, pumpkin seed, potato, chickpea, lentil, sunflower seed, peanut, almond and hazelnut protein powder.

In one embodiment the source of plant protein comprises pea protein concentrate, fava protein concentrate, soy protein concentrate, mung bean protein concentrate, gluten protein concentrate or a mixture thereof.

In one embodiment the source of plant protein comprises about 2, 5, 7, 10, 15, 20, 25, 30 35, 40, 45, 50, 55, 60, 65, 70, 75, 80, 85, 90, 95 or 97.5 to about 100 wt % soy protein powder. In one embodiment the plant protein comprises about 2, 5, 7, 10, 15, 20, 25, 30 35, 40, 45, 50, 55, 60, 65, 70, 75, 80, 85, 90, 95 or 97.5 to about 100 wt % pea protein powder.

In one embodiment the source of plant protein comprises or consists essentially of pea protein concentrate, fava protein concentrate, soy protein concentrate, or a mixture thereof.

In one embodiment the source of plant protein comprises or consists essentially of about 50:40:10 pea protein: fava protein: soy protein.

In one embodiment the source of plant protein comprises or consists essentially of about 50 wt % pea protein concentrate, about 40 wt % fava protein concentrate and about 10 wt % soy protein concentrate.

The composition comprising a source of plant protein may also include up to about 10 wt % lipid. In one embodiment, the lipid is a vegetable oil or mixture of vegetable oils.

The lipid may also comprise one or more fats, such as coconut oil, shea butter, cocoa butter and hydrogenated oils, provided they are melted before use.

Examples of suitable lipids include, but are not limited to, canola oil, sunflower oil, safflower oil, soybean oil, avocado oil, olive oil, corn oil, flaxseed oil, almond oil, coconut oil, peanut oil, pecan oil, cottonseed oil, algal oil, palm oil, palm olein, palm kernel oil, tucuma fruit oil, rice bran oil, wheat germ oil, evening primrose oil, sesame oil, butteroil, cocoa butter, grape seed oil, rapeseed oil, mustard oil, hazelnut oil, brazil nut oil, linseed oil, acai palm oil, passion fruit oil, walnut oil, shea butter, shea stearin, shea olein, palm kernel stearin, palm kernel olein and mixtures thereof.

In one embodiment the lipid is canola or sunflower oil.

The lipid lubricates the source of plant protein aiding the extrusion process.

In one embodiment, up to about 10 wt % lipid is extruded with the source of plant protein in step (b), preferably about 1 to about 8 wt %, more preferably about 3 to about 7 wt %, most preferably about 5 wt %. 5 wt % lipid means 5 g per 100 g protein mix on a dry basis.

In one embodiment, salt is also added to the extrusion mixture in step (a). The amount of salt needed depends on the desired taste profile. In one embodiment, about 0.1 to about 6 wt % salt is added, preferably about 4 wt %.

In step (b) the composition comprising a source of plant protein and optionally lipid is subject to high moisture extrusion to form a semi-solid, texturized mass.

As used herein, the term “high moisture extrusion” and related terms such as “extruding” refer to the continuous thermomechanical process in which dry food ingredients are mixed, hydrated, heated and subjected to shear, pressure and cooking to produce a food product with different textural properties to the food ingredient mixture.

The high moisture extrusion step of the present process replaces the step of coagulation in the manufacture of a dairy-based cheese. The latter is typically achieved by using the enzyme rennet. The rennet coagulation step creates a continuous, cross-linked mass of dairy proteins (primarily casein), which is not possible to achieve using plant proteins.

However, in the present process, the plant proteins are blended and fused together during extrusion to form a texturized mass comprising globular amorphous particles of proteins from different sources blended into a concentrated mass containing cross-linked and fused protein molecules.

Extrusion is carried out in a high moisture extruder, which is typically a large, rotating screw (or screws) tightly fitted within a stationary barrel. Steam is injected at the start of the process and the forces created by the rotating screw generate further friction and heat. The shear force exerted by the rotating screw blends and fuses the source of plant protein and optional lipid providing a semi-solid texturized mass.

The optimum feed moisture (relative proportion of water added to the extruder) depends on the nature of the protein source. If the feed moisture is too low, the plant protein material being extruded will be too hard and may block the extruder barrel. If the feed moisture is too high, the extruded plant protein mass will not have the necessary physical structure and will result in a pasty mass. A person skilled in the art would know how to vary the feed moisture depending on the composition to be extruded.

In one embodiment the feed moisture in step (b) is about 40 to 80 wt %, relative to the source of protein, preferably about 50 to 70 wt % more preferably about 54 to 62 wt %.

In one embodiment the extruder is a twin-screw extruder. In one embodiment the screw speed is about 300-500 rpm.

In step (c) the extruded, semi-solid texturized mass is shredded to provide a granular material. Shredding is essential for achieving a uniform texture in the plant-based cheese product. It also ensures that the enzymes incubated in step (d) are in contact with all of the material.

The extruded, semi-solid, texturized mass can be shredded using any suitable size reduction apparatus capable of handling semi-solid material. Examples of suitable apparatus include but are not limited to, wet grinders and food processors and other apparatus using high speed chopping blades.

In one embodiment the granular material has an average particle size of about 100 μm to about 6 mm diameter, preferably about 100 μm to about 3 mm diameter and more preferably about 1.5 mm. The average particle size can be measured using multiple sieves of different mesh sizes.

In step (d) the granular material is mixed with lipid and incubated one or more protease or protein cross-linking enzymes.

In one embodiment, the granular material is mixed with lipid and then incubated with one or more protease or protein cross-linking enzymes. In another embodiment, the granular material is incubated with one or more protease or protein cross-linking enzymes and then mixed with lipid.

In one embodiment, about 5, 7.5, 10, 12.5, 15, 20, or 30 to about 40 wt % lipid is added, relative to the weight of final product.

In one embodiment about 10 to about 30 wt % lipid is added.

The lipid may be in any suitable form including pure and emulsified forms. In one embodiment, the granular material is mixed with an emulsified lipid. The emulsified lipid may comprise any edible emulsifier including but not limited to lecithin, mono- and diglycerides, polysorbates, gum arabic, and plant proteins, as well as emulsifying salts such as sodium citrate, sodium-potassium tartrate, disodium salt of orthophosphoric acid) In one embodiment the emulsified lipid comprises a lipid, plant protein and water.

Examples of suitable lipids include, but are not limited to, canola oil, sunflower oil, safflower oil, soybean oil, avocado oil, olive oil, corn oil, flaxseed oil, almond oil, coconut oil, margarine, tucuma fruit butter, hydrogenated oils, non-hydrogenated hard oils, milk fat replacers, peanut oil, pecan oil, cottonseed oil, algal oil, palm oil, palm olein, palm kernel oil, rice bran oil, wheat germ oil, evening primrose oil, sesame oil, butteroil, cocoa butter, grape seed oil, rapeseed oil, mustard oil, hazelnut oil, brazil nut oil, linseed oil, acai palm oil, passion fruit oil, walnut oil, shea butter, shea stearin, shea olein, palm kernel stearin, palm kernel olein and mixtures thereof.

In one embodiment the lipid is a vegetable oil, for example, canola oil, rice bran oil, coconut oil, soy oil or sunflower oil.

The selection of a suitable lipid depends on the type of plant-based cheese product desired. Lipids rich in saturated fatty acids such as coconut oil give solidity to the product and help build structure. Such lipids are preferred in the manufacture of hard or semi-hard cheese products. Lipids rich in polyunsaturated fatty acids such as sunflower oil and canola oil are better suited to soft cheese products analogous to cream cheese.

In one embodiment the lipid is selected from coconut oil, shea butter, palm oil, hydrogenated oils, margarine, non-hydrogenated hard oils and other lipids that are solid at room temperature. In one embodiment the lipid is coconut oil and/or palm oil.

In one embodiment the lipid is selected from sunflower oil and canola oil.

The plant-protein based texturized granular mass can also be mixed with milk proteins derived from non-animal sources (for example caseins and whey proteins produced from plants, microbes, and yeast through recombinant technology and genetic engineering) to yield a plant-based cheese product closer to a real dairy cheese with the common functionalities obtainable using an animal based dairy casein. Milk proteins derived from non-animal sources may alternatively or additionally be combined with the source of plant protein prior to extrusion.

The type of enzyme used in step (d) will depend on the type of plant-based cheese product being made.

To achieve certain specific textural properties, such as melting and spreadability, the granular material is incubated with one or more proteases.

Any plant-based or microbial-based protease can be used. Proteases suitable for use in the process of the invention include, but are not limited to, papain, bromelain, actinidin, zingibain, chymosin, trypsin and chymotrypsin. A person skilled in the art would be able to select a suitable protease depending on the properties desired in the plant-based cheese products.

Different proteases have different usage dose and optimum temperatures. Generally, the manufacturers' instructions will be followed for optimum conditions.

In one embodiment, the enzyme is a microbial protease incubated at 0.1 g to 2 g/100 g of final product at a temperature of about 20 to about 70° C.

Optionally, the incubating mixture of granular material and enzyme can be further blended, for example, in a dough blender.

In one embodiment about 1 g microbial protease is added granular material containing 100 g protein at 20° C., the mixture is blended intermittently for about 30 min at about 50° C. in the blender, and then left at about 20° C. for about 1.5 h.

In one embodiment the enzyme is a plant-based protease. In one embodiment the enzyme is a microbial protease, preferably a fermentation product of Bacillus sp. or Aspergillus sp. protease.

For plant-based non-melting cheese products (similar to Haloumi and Paneer) the granular material is incubated with one or more protein cross-linking enzymes, for example, transglutaminase or oxidoreductases such as tyrosinase, laccase, peroxidase, lysyl oxidase/amine oxidase or genipin.

Protein crosslinking enzyme such as transglutaminase provide a rubbery structure to the granular paste. In one embodiment, about 0.5 to about 3 g microbial transglutaminase is added to granular material containing 100 g protein at about 4-60° C., preferably 40° C., for about 1 to 5 about hours.

Additional water may be added to the incubation mixture to achieve the desired texture in the product, particularly when a cross-linking enzyme is used.

Following incubation in step (d), the mixture is treated so as to inactivate the enzymes in step (e). In one embodiment the incubated mixture is heated to about 80 to about 100° C. for 5 minutes (preferably about 95° C. for 5 min) to inactivate the enzymes. In another embodiment, the pH of the incubation mixture is lowered to inactivate the enzymes.

The resulting material is cooled to provide a plant-based cheese product comprising about 5 wt % to about 40 wt % protein. In one embodiment the plant-based cheese product of the invention comprises about 10 wt % to about 40 wt % protein.

In one embodiment the plant-based cheese product is moulded into a desired shape, for example, by pouring the hot or warm enzyme inactivated mixture into a mould and allowing it to cool in the shape of the mould.

As discussed above, the process of the invention can be used to produce a range of plant-based cheese products. The selection of enzyme (protease or protein cross-linking) will determine the melting characteristics of the product. The selection and amount of lipid added in step (d) will influence the hardness and fat content of the product.

The optional addition of thickening and/or gelling agents can also alter the structural properties of the product, as well as lowering its fat and protein content.

Gelling agents provide a three-dimensional structural network with a high degree of physical cross-linking. Thickening agents increase the viscosity of a liquid and may also improve the suspension of other ingredients or stablise emulsions. Many thickening agents also act as gelling agents at high concentration.

Thickening and/or gelling agents typically comprise hydrocolloids and/or proteins. They are generally provided as powders to be dissolved in a liquid phase (typically water) or in pre-dissolved liquid form.

Examples of thickening and/or gelling agents suitable for use in the process of the invention include but are not limited to, microbial and vegetable gums such as alginin, guar gum, locust bean gum, gellan gum, carrageenan gum, tara gum, gum arabic, Konjac, xanthan gum, flour, starches (including but not limited to potato, tapioca, wheat, corn and rice), modified starches (including chemically and enzymatically modified starches), maltodextrins, dextrins and mixtures thereof.

A gelling agent would typically be added in the manufacture of a melting-type plant-based cheese product, to provide a sliceable product, similar to a processed dairy-based cheese. A thickening agent would typically be added in the manufacture of a plant-based spreadable cheese product.

The thickening and/or gelling agent can be added at any appropriate stage of the process following high moisture extrusion and shredding of the extruded, texturized semi-solid mass. A person skilled in the art would understand the best time and manner in which the particular agent should be added. In one embodiment, one or more thickening and/or gelling agents are added to the granular material in the process of the invention.

In one embodiment about 0.1 to 3 wt % thickening and/or gelling agent is added, relative to the final product. In one embodiment about 0.8 to about 1.3 wt % thickening and/or gelling agent is added (for a semi-hard plant-based cheese product). In one embodiment about 1.3 to about 2.5 wt % thickening and/or gelling agent is added (for a sliceable plant-based cheese product similar to processed cheese).

In one embodiment the thickening and/or gelling agent is a hydrocolloid, preferably a polysaccharide. In one embodiment the thickening and/or gelling agent is carrageenan gum. In one embodiment the thickening and/or gelling agent is starch (range 1-25% wt of the final product), preferably 10-22 wt %.

In one embodiment the thickening and/or gelling agent is added prior to enzyme incubation. In one embodiment the thickening and/or gelling agent is added following enzyme incubation prior to enzyme inactivation. In one embodiment the thickening and/or gelling agent is added following enzyme inactivation.

Preservatives, anti-oxidants, nutrients, colouring agents (including but are not limited to annatto, food colours, carrot or pumpkin juice concentrate, carotenes, curcumin, beta carotenes and natural colours), emulsifiers (including but not limited to emulsifying salts such as sodium citrate, sodium-potassium tartrate, disodium salt of orthophosphoric acid and lecithin, plant proteins) and flavouring agents may be added at any appropriate step in the process, including being mixed with the initial plant protein source and optional lipid in step (b), with the lipid added in step (d) or added to the enzyme incubation mixture. Ingredients that are sensitive to heat should be added after the enzyme deactivation step (e).

Nutrients that may be added include but are not limited to vitamins (eg, vitamin A, C, E, K, D, thiamine (vitamin B1), riboflavin (vitamin B2), niacin (Vitamin B3), vitamin B6, folic acid (vitamin B9), and/or vitamin B12, and mixtures thereof), minerals (eg, calcium, phosphorous, magnesium, sodium, potassium, chloride, iron, zinc, iodine, selenium, copper and mixtures thereof), various forms of synthetic amino acids (including but not limited to lysine, methionine and mixtures thereof), dietary fibres (including but not limited to soluble fibres such as inulin), and edible salts (including but not limited to sodium chloride, calcium phosphate, calcium chloride and the like.).

Examples of flavouring agents suitable for use in the process of the invention include but are not limited to, salt, sugar, spices, herbs, yeast extracts, miso, and mixtures thereof. Cheese flavour agents (non-dairy) may also be added including peptides and amino acids and free fatty acids such as butyric, lauric and capric acids. Flavour masking agents can also be used to mask plant-based beany flavours.

Various food acids can be added to provide an acidic flavour and to reduce the pH of the cheese product. Examples of food acids include but are not limited to lactic acid, citric acid, sorbic acid, vinegar, ascorbic acid, lemon juice, apple juice concentrate, sodium lactate, trisodium citrate, and mixtures thereof.

In one embodiment lactic acid is added is added during manufacture of the plant-based cheese product of the invention. Lactic acid is generally provided in aqueous solution. In one embodiment, lactic acid solution is added so as to give a concentration of about 0.2 to about 2.0 wt % lactic acid in the final product. In one embodiment, lactic acid is added after enzyme incubation and before enzyme inactivation.

The plant-based cheese product made by the process of the invention may be aged and/or microbially ripened (for example, by adding non-dairy starter cultures) in the same way that dairy-based cheeses are aged. Aging times vary from weeks to years, depending on the type of cheese product and desired flavour profile.

### 4.3 The Plant-Based Cheese Products of the Invention

In one aspect the invention provides a plant-based cheese product comprising about 5 wt % to about 40 wt % protein, preferably about 7, 8, 10, 12, 15, 18, 20, 22 or 25 wt % to about 35 wt % protein.

In one embodiment, the plant-based cheese product is a melting cheese product. In one embodiment the plant-based melting cheese product comprises about 15 to about 33 wt % protein.

Examples 1, 2, 3, 5, 6 and 7 describe the process of making a plant-based melting cheese product of the invention.

In one embodiment the meltability of the plant-based melting cheese product (measured using the Schreiber test) is about 10 to about 40%, preferably about 15 to about 30%, more preferably about 20 to 30%.

In another aspect the invention provides a plant-based cheese product comprising about 25 to about 35 wt % protein powder, about 15 to about 25 wt % lipid, about 40 to about 45 wt % water and about 0.5 to about 2.0 wt % lactic acid, wherein the total wt % of the components is 100 or less.

In one embodiment, the plant-based cheese product is a soft/semi-soft product. In one embodiment the plant-based cheese product is a meltable cheese product.

In another aspect the invention provides a plant-based cheese product comprising about 22 to about 33 wt % protein powder, about 13 to about 22 wt % lipid, about 45 to about 50 wt % water and about 0.5 to about 2.0 wt % lactic acid, wherein the total wt % of the components is 100 or less.

In one embodiment, the plant-based cheese product is a semi-hard product. In one embodiment the plant-based semi-hard cheese product is a meltable cheese product.

In another aspect the invention provides a plant-based cheese product comprising about 14 to about 24 wt % protein powder, about 8 to about 16 wt % lipid, about 55 to about 70 wt % water and about 0.5 to about 2.0 wt % lactic acid, wherein the total wt % of the components is 100 or less.

In one embodiment, the plant-based cheese product is a sliceable product. In one embodiment the plant-based sliceable cheese product is a meltable cheese product.

In another aspect the invention provides a plant-based cheese product comprising about 18 to about 30 wt % protein powder, about 10 to about 18 wt % lipid, about 55 to about 70 wt % water and about 0.5 to about 2.0 wt % lactic acid, wherein the total wt % of the components is 100 or less.

In one embodiment, the plant-based cheese product comprises milk protein derived from non-animal sources.

In one embodiment, the plant-based cheese product is a non-melting cheese product.

In one embodiment the plant-based non-melting cheese product comprises about 18 to about 25 wt % protein.

In the above aspects, in one embodiment, the protein powder comprises or consists of pea protein concentrate, fava protein concentrate and soy protein concentrate. In one embodiment the source of plant protein comprises or consists essentially of about 50:40:10 pea protein: fava protein: soy protein.

Example 9 compares a plant-based melting cheese product of the invention with a comparable cheese product produced with the same ingredients, but without the extrusion and enzymatic hydrolysis steps. The results show that the process of the invention results in a cheese product with superior textural and physical properties. Without being bound by theory, it is believed that these properties result from the particular steps of the process, which change the microstructure of the product; i.e. the distribution and shape of the lipids within the matrix of protein and the distribution of protein aggregates or clusters (homogenous or non-homogenous) within the “cheese” network which are important for cheese functionality (mouthfeel, melting, texture, etc.).

Microstructural analysis demonstrates that the plant-based cheese products of the invention differ structurally from commercially available plant-based cheese products. In the latter, the lipids are distributed throughout a matrix of starch and hydrocolloids to achieve desired functionality due to their lower protein content.

In Examples 10 and 11, plant-based cheese products of the invention were compared with a selection of other plant-based cheese products (vegan cheeses) and comparable dairy cheeses (ie, cheeses of the same basic type such as hard, semi-soft, non-melting etc). The results showed that the plant-based cheese product of the invention had similar sliceability, spreadability, texture, flavour, hardness, meltability and stretchability to the comparable dairy-based cheeses, The “dairy cheese-like” functional properties of the plant-based cheese product of the invention also gave rise to sensory properties that were comparable to those of dairy cheese.

Accordingly, the process of the invention can be used to make a plant-based cheese products that do not suffer the disadvantages associated with comparable plant-based products, as well as being similar in protein content and textural and sensory properties to dairy cheese.

### 4. EXAMPLES

### Example 1: Soft/Semi-Soft Plant-Based Melting Cheese Product

A soft/semi-soft plant-based cheese product was prepared using the ingredients in Table 1 below.

The protein powders were mixed with the canola oil and salt before extrusion.

All extrusion experiments were performed using a pilot-scale, co-rotating, and intermeshing twin-screw extruder (Clextral BC-21, Firminy Cedex, France). The operating parameters were set as followed: screw diameter—25 mm; total screw length—700 mm; length/diameter ratio of screw—28:1; barrel diameter—26 mm; and a long cylindrical cooling die with diameter of 10/355 mm was attached at the end of the extruder. The screw profile comprised (from feed to exit) of: two 50 mm length, 20 mm pitch, forward screw (100 mm); three 50 mm length, 15 mm pitch, forward screw (150 mm); two 50 mm, 10 mm pitch, forward screw (100 mm); one 50 mm, 15 mm pitch, forward screw (50 mm), one 25 mm, 7 mm pitch, reverse screw (25 mm); one 50 mm, 15 mm pitch, forward screw (50 mm), one 25 mm, 7 mm pitch, forward screw (25 mm); and four 50 mm, 7 mm pitch, forward screw (200 mm). The barrel was segmented into the feeding zone (T1) and six temperature-controlled zones (T2 to T7), which was heated by steam and cooled by running water pipes (˜25° C.).

A gravimetric feeder (K-ML-D5-KT20 and LWF D5, Coperion K-Tron, Switzerland) was used to feed the dry ingredients into the extruder at a rate of 2.4 to 3.0 kg/h.

Water was injected into the extruder through an inlet port at a constant flow of 3.0 kg/h to obtain a moisture content of approximately 50-55% w/w (wet basis) in the final product.

The screw speed was 400 rpm and the barrel temperatures were set at 20, 50, 80, 110, 150, 150 and 150° C. in the seven zones from feed to die. The extruded semi-solid, texturized mass was shredded using a high-speed chopping blade to a granular material.

The coconut oil (heated to about 60° C.) and microbial proteinase (ZymPro Neutral from ZYMUS International Ltd, Avondale, Auckland) were mixed with the granular material and left to incubate at room temperature for 2 hours.

Lactic acid and cheese flavour were added and the product mixed and heat treated at 95° C. After heating for 5 minutes the resulting product was cooled and shaped to give a plant-based cheese product of the invention.

TABLE 1
Ingredients

| Ingredients | Quantity (g) | Percentage |
|---|---|---|
| Pea Protein concentrate (85%) | 32.85 | 16.26% |
| Fava protein concentrate (85%) | 26.28 | 13.00% |
| Soy protein concentrate (85%) | 6.57 | 3.25% |
| Salt | 2.73 | 1.35% |
| Canola oil | 3.5 | 1.73% |
| Water added during extrusion | 88 | 43.55% |
| Coconut oil | 37.5 | 18.56% |
| Enzyme (protease, microbial source) | 0.65 | 0.32% |
| Cheese flavour | 2 | 0.99% |
| Lactic acid | 2 | 0.99% |
| Total | 202.08 | 100.00% |

The plant-based cheese product had a protein content of 27.6 wt % with a pea protein:fava protein:soy protein ratio of about 50:40:10.

### Example 2: Semi-Hard Plant-Based Melting Cheese Product

A semi-hard plant-based cheese product was prepared using the ingredients in Table 2 below.

The protein powders were mixed with the canola oil and salt before extrusion. The extrusion process was carried out as described in Example 1. The extruded semi-solid texturized, mass was shredded using a high-speed chopping blade to produce a granular material.

The coconut oil (heated to about 60° C.) and microbial proteinase were mixed with the granular material and left to incubate at room temperature for 2 hours. Lactic acid and carrageenan gum dissolved in water were added and the product mixed and heat treated at 95° C. After heating for 5 minutes the cheese flavour was added and the product hot moulded to give a plant-based cheese product of the invention.

TABLE 2
Ingredients

| Ingredients | Quantity (g) | Percentage |
|---|---|---|
| Pea Protein concentrate (85%) | 32.85 | 13.96% |
| Fava protein concentrate (85%) | 26.28 | 11.17% |
| Soy protein concentrate (85%) | 6.57 | 2.79% |
| Salt | 2.81 | 1.19% |
| Canola oil | 3.61 | 1.53% |
| Water added during extrusion | 88 | 37.40% |
| Coconut oil | 37.5 | 15.94% |
| Enzyme (protease, microbial source) | 0.65 | 0.28% |
| Carrageenan (low) | 3 | 1.28% |
| Cheese flavour | 2 | 0.85% |
| Additional water added with gum | 30 | 12.75% |
| Lactic acid | 2 | 0.85% |
| Total | 235.27 | 100.00% |

The plant-based cheese product had a protein content of 23.6 wt % with a pea protein:fava protein:soy protein ratio of about 50:40:10.

### Example 3: Sliceable Plant-Based Melting Cheese Product

A sliceable plant-based cheese product was prepared using the ingredients in Table 3 below.

The protein powders were mixed with the canola oil and salt before extrusion. The extrusion process was carried out as described in Example 1. The extruded, texturized, semi-solid mass was shredded using a high-speed chopping blade to produce a granular material.

The coconut oil (heated to about 60° C.) and microbial proteinase (ZymPro Neutral from ZYMUS International Ltd, Avondale, Auckland) were mixed with the granular material and left to incubate at room temperature for 2 hours. Lactic acid and carrageenan gum dissolved in water were added and the product mixed and heat treated at 95° C. After heating for 5 minutes the cheese flavour was added and the product hot moulded to give a plant-based cheese product of the invention.

TABLE 3
Ingredients

| Ingredients | Quantity (g) | Percentage |
|---|---|---|
| Pea Protein concentrate (85%) | 32.85 | 9.70% |
| Fava protein concentrate (85%) | 26.28 | 7.76% |
| Soy protein concentrate (85%) | 6.57 | 1.94% |
| Salt | 2.81 | 0.83% |
| Canola oil | 3.61 | 1.07% |
| Water added during extrusion | 88 | 25.98% |
| Coconut oil | 37.5 | 11.07% |
| Enzyme (protease, microbial source) | 0.65 | 0.19% |
| Carrageenan (high) | 6.5 | 1.92% |
| Cheese flavour | 2 | 0.59% |
| Additional water added with gum | 130 | 38.37% |
| Lactic acid | 2 | 0.59% |
| Total | 338.77 | 100.00% |

The plant-based cheese product had a protein content of 16.5 wt % with a pea protein:fava protein:soy protein ratio of about 50:40:10.

### Example 4: Plant-Based Non-Melting Cheese Product

A plant-based non-melting cheese product was prepared using the ingredients in Table 4 below.

The protein powders were mixed with the canola oil and salt before extrusion. The extrusion process was carried out as described in Example 1.

The extruded texturized, semi-solid mass was shredded using a high-speed chopping blade to form a granular material.

The melted coconut oil, microbial transglutaminase (Saprona Best (300) from C&P Group GmbH, Rosshaupten, Germany), additional water and cheese flavour were mixed with the granular material and left to incubate at room temperature for 4 hours before cooling to produce the plant-based cheese product of the invention.

TABLE 4
Ingredients

| Ingredients | Quantity (g) | Percentage |
|---|---|---|
| Pea Protein concentrate (85%) | 32.85 | 11.62% |
| Fava protein concentrate (85%) | 26.28 | 9.30% |
| Soy protein concentrate (85%) | 6.57 | 2.32% |
| Salt | 2.73 | 0.97% |
| Canola oil | 3.5 | 1.24% |
| Water added during extrusion | 120 | 42.44% |
| Coconut oil | 37.5 | 13.26% |
| Enzyme (Transglutaminase (TG), | 1.3 | 0.46% |
| microbial source) | | |
| Cheese flavour | 2 | 0.71% |
| Additional water | 50 | 17.68% |
| Total | 282.73 | 100.00% |

The product had a protein content of 19.7 wt % with a pea protein: fava protein: soy protein ratio of about 50:40:10.

### Example 5: Plant-Based Melting Cheese Product with Coconut Oil Emulsion

A plant-based cheese product was prepared using the ingredients in Table 5 below.

The protein powders were mixed with the canola oil and salt before extrusion. The extrusion process was carried out as described in Example 1.

The extruded texturized, semi-solid mass was shredded using a high-speed chopping blade to form a granular material.

The coconut oil emulsion, microbial protease, flavourings, colour, gum, etc, were mixed and heated to boiling point before the mixture was hot moulded to provide the plant-based cheese product of the invention.

TABLE 5
Ingredients

| Ingredients | Quantity (g) | Percentage |
|---|---|---|
| Pea Protein concentrate (85%) | 34.1 | 11.52% |
| Fava protein concentrate (85%) | 27.3 | 9.23% |
| Soy protein concentrate (85%) | 6.8 | 2.30% |
| Canola oil | 3.75 | 1.27% |
| Salt | 3 | 0.68% |
| Water added during extrusion | 75 | 25.35% |
| Coconut oil^{a} | 37.5 | 12.67% |
| Soy protein concentrate^{a} | 10.5 | 3.55% |
| Water^{a} | 85 | 28.73% |
| Enzyme (protease, microbial source) | 2 | 0.68% |
| Carrageenan | 3.8 | 1.31% |
| Lactic acid | 2 | 0.68% |
| Annatto colour | 0.4 | 0.14% |
| Cheese flavour | 2.3 | 0.78% |
| Calcium phosphate | 0.75 | 0.25% |
| Total | 295.9 | 100.00% |

^{a}These ingredients comprise coconut oil emulsion.
The plant-based cheese product had a protein content of 22.3 wt % with a pea protein:fava protein:soy protein ratio of 50:40:¹⁰

### Example 6: Plant-Based Melting Cheese Product with Milk Protein

A plant-based cheese product was prepared using the ingredients in Table 6 below.

The protein powders and milk protein concentrate were mixed with the canola oil and salt before extrusion. The extrusion process was carried out as described in Example 1.

The extruded texturized, semi-solid mass was shredded using a high-speed chopping blade to form a granular material.

The coconut oil and microbial protease were added, and the mixture left at room temperature for 3 hours. The lactic acid, gum, additional water, flavourings, colour, gum, etc, were mixed and heated to boiling point before the mixture was hot moulded to provide the plant-based cheese product of the invention.

TABLE 6
Ingredients

| Ingredients | Quantity (g) | Percentage |
|---|---|---|
| Milk Protein Concentrate | 35 | 12.73% |
| Pea Protein concentrate (85%) | 17.1 | 6.22% |
| Fava protein concentrate (85%) | 13.6 | 4.95% |
| Soy protein concentrate (85%) | 3.4 | 1.24% |
| Canola oil | 1.6 | 0.58% |
| Salt | 3 | 1.09% |
| Water added during extrusion | 75 | 27.28% |
| Coconut oil | 37.5 | 13.64% |
| Enzyme (protease, microbial source) | 2 | 0.73% |
| Carrageenan | 3.8 | 1.38% |
| Lactic acid | 2 | 0.73% |
| Annatto colour | 0.4 | 0.15% |
| Cheese flavour | 2.3 | 0.84% |
| Calcium phosphate | 0.75 | 0.27% |
| Additional Water | 77.5 | 28.19% |
| Total | 274.95 | 100.00% |

The plant-based cheese product had a protein content of 21.3 wt % with a milk protein concentrate: pea protein:fava protein:soy protein ratio of 50:25:20:5

### Example 7: Plant-Based Cheese Product for Analysis (Riddet Cheese Product)

A plant-based melting cheese product was prepared using the ingredients in Table 7 below.

The protein powders were mixed with the canola oil and salt before extrusion. The extrusion process was carried out as described in Example 1.

The extruded texturized, semi-solid mass was shredded using a high-speed chopping blade to form a granular material.

The coconut oil and microbial protease were mixed and heated to 50° C. then left for 3 hours with intermittent mixing. The remaining ingredients were added and the mixture heated to 95° C. and left for 5 minutes before the mixture was hot moulded and then refrigerated to provide a plant-based cheese product of the invention.

TABLE 7
Ingredients

| Ingredients | Quantity (g) | Percentage |
|---|---|---|
| Pea Protein concentrate (85%) | 34.8 | 12.04% |
| Fava protein concentrate (65%) | 27.9 | 9.65% |
| Soy protein concentrate (85%) | 7 | 2.42% |
| Canola oil | 3.67 | 1.27% |
| Salt | 4 | 1.38% |
| Water added during extrusion | 82.7 | 28.61% |
| Coconut oil | 37.5 | 12.97% |
| Enzyme (Protease) | 2 | 0.69% |
| Carrageenan | 3.8 | 1.31% |
| Lactic acid | 2 | 0.69% |
| Colour | 0.4 | 0.14% |
| Flavour | 2.3 | 0.80% |
| Potassium sorbate | 0.28 | 0.10% |
| Calcium phosphate | 0.75 | 0.26% |
| Additional water | 80 | 27.67% |
| Total | 289.1 | 100.00% |

The plant-based cheese product had a protein content of 18.5 wt % with a pea protein:fava protein:soy protein ratio of 50:40:10.

### Example 8: Plant-Based Cheese Product for Analysis (Control Cheese Product)

A plant-based cheese product (Control cheese product) was prepared using the ingredients in Table 8 below.

All ingredients were mixed in a high-speed blender for 5 min then mixed intermittently for 3 hours, before being heated to 95° C. for 5 minutes, mixed again and hot moulded. The mixture was refrigerated to complete the moulding process.

TABLE 8
Ingredients

| Ingredients | Quantity (g) | Percentage |
|---|---|---|
| Pea Protein concentrate (85%) | 34.8 | 12.04% |
| Fava protein concentrate (65%) | 27.9 | 9.65% |
| Soy protein concentrate (85%) | 7 | 2.42% |
| Canola oil | 3.67 | 1.27% |
| Water | 164.7 | 56.97% |
| Coconut oil | 37.5 | 12.97% |
| Salt | 4 | 1.38% |
| Carrageenan | 3.8 | 1.31% |
| Lactic acid | 2 | 0.69% |
| Colour | 0.4 | 0.14% |
| Flavour | 2.3 | 0.80% |
| Potassium sorbate | 0.28 | 0.10% |
| Calcium phosphate | 0.75 | 0.26% |
| Total | 289.1 | 100.00% |

The Control cheese product had a protein content of 18.5 wt % with a pea protein:fava protein:soy protein ratio of 50:40:10.

### Example 9: Texture Analysis, Rheology, Meltability and Sensory Analysis of Riddet Cheese Product Compared with Control Cheese Product

The plant-based cheese products produced in Examples 7 and 8 were compared.

### Methods:

The protein content of the Riddet plant-based cheese product or control cheese product was analysed following the AOAC Official Methods of Analysis. A factor of 6.25 was used for calculation of the total protein content of all the plant-based cheese products made in-house. The protein content of the commercial dairy and commercial vegan cheese products tested was taken from their respective nutrition labels printed on the pack by their manufacturers.

The texture of the plant-based cheese products was confirmed by Textural Profile Analysis (TPA). TPA measures the response of the cheese products to double-bite deformation and assesses key parameters of relevance during consumer mastication, simulating the several compressions of the product between the molar teeth. The products' hardness, springiness, cohesiveness, gumminess, and chewiness were calculated following the double compression tests. “Hardness” is the force required to deform the product to given distance, i.e., force to compress between molars, bite through with incisors, compress between tongue and palate; “springiness” is the degree to which the product returns to its original size/shape after partial compression (without failure) between the tongue and palate or teeth; “cohesiveness” is the degree to which the sample deforms before rupturing when its bitten with molars; gumminess is the energy required to disintegrate a semi-solid food to a state ready for swallowing; and chewiness is the number of chews needed to masticate the sample to a consistency suitable for swallowing.

The pHs of homogenized slurries of the cheese products were measuring using a PH meter.

Moisture content analysis is one of the important approaches for determining a product's properties and behaviour. The moisture content of the cheese products was determined by the air oven method, where around 1.0-1.5 g of material was weighed accurately into each moisture dishes and dried in an air oven for 4 hours at 108° C. From this method, moisture loss and dry matter changes of the cheese products were calculated. Hence, the moisture content (%) of the samples was determined.

The water activity (aw) of the cheese products (a small section) was measured at 20° C. using a water activity meter. The water activity of the products is important in determining their shelf life. The water activity of the products is influenced by the concentration and distribution of salt and other components which can have a preservative effect.

The meltability of the plant-based cheese products was assessed using the Schreiber test with minor modifications. Specimens of dimensions height 5 mm and diameter 30 mm were placed in a covered glass petri dish, then heated in an oven at 232° C. (forced air-oven for 5 min) and cooled. The specimen expansion was measured. Meltability was calculated using the mean of the three readings and expressed as percentage specimen expansion (%). The results of this test represent the ease and extent to which cheese products melt and spread upon heating, indicating the low and high meltability cheeses.

Dynamic low amplitude oscillatory shear rheology was performed on the cheese products using a rheometer and following a temperature ramp procedure (where the temperature changed from 16 to 85° C. at a ramp rate of 5° C./min by applying force at a constant frequency of 1 Hz). The parameter considered is storage modulus (G′). This test provides indications about the changes in the viscoelastic behaviour of the cheese products with temperature (i.e., solid-like and liquid-like properties as a result of stress).

### Results:

The results of the textural analysis are shown in Table 9. The hardness, gumminess, and chewiness of the Control cheese product were much higher than for the Riddet cheese product.

TABLE 9
Textural analysis data for plant-based cheese products

| | Hardness | | | | |
|---|---|---|---|---|---|
| Sample | (g) | Springiness | Cohesiveness | Gumminess | Chewiness |
| Riddet | 1294 ± 147 | 0.742 ± 0.024 | 0.554 ± 0.014 | 716 ± 74 | 532 ± 68 |
| cheese | | | | | |
| product | | | | | |
| Control | 4593 ± 147 | 0.766 ± 0.019 | 0.634 ± 0.021 | 2911 ± 124 | 2230 ± 87 |
| cheese | | | | | |
| product | | | | | |

These results indicate that the Riddet cheese product will have better mouthfeel and meltability in the mouth compared to the Control cheese product, which would be expected to be more brittle and crumblier in the mouth.

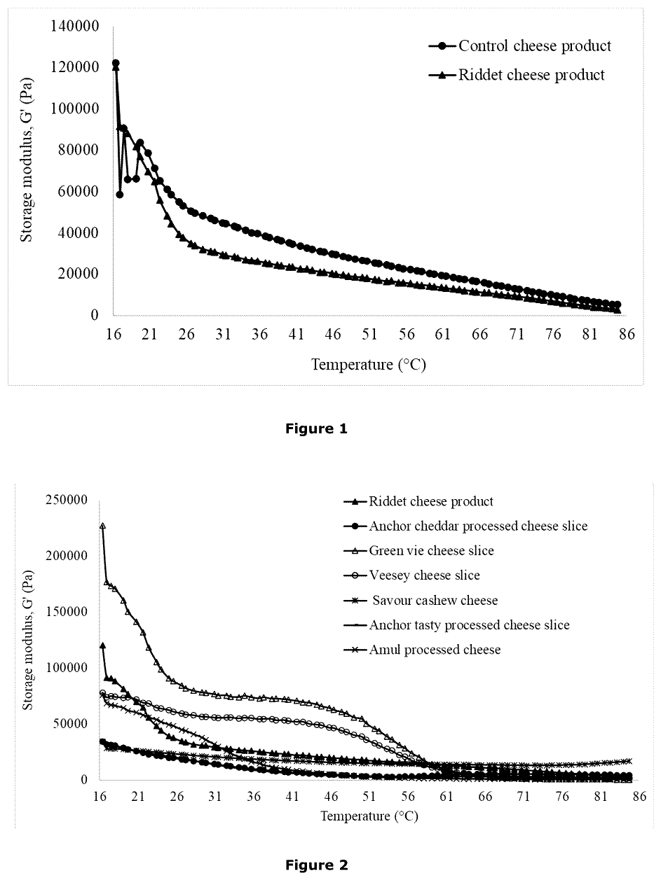

The rheology results (see FIG. 1) further support the texture analysis results of Table 9. Upon heating from 16-85° C., the strength (indirectly hardness) of the Riddet cheese product decreased at a much faster rate compared to the Control cheese product. This data also indicates that as the temperature is increased, the Riddet cheese product melts, spreads or softens better.

The meltability and other characteristics of the two plant-based cheese products were compared, as set out in Table 10.

TABLE 10
Meltability

| | | Moisture Content | Water Activity | Meltability |
|---|---|---|---|---|
| Sample | pH | (%) | (Aw) | (%) |
| Riddet cheese | ~5.63 | 55.35 ± 0.42 | 0.965 ± 0.002 | 25.68 ± 0.32 |
| product | | | | |
| Control | ~5.6 | 56.22 ± 0.46 | 0.968 ± 0.002 | 0.00 ± 0.00 |
| cheese product | | | | |

Even though both cheese products have very similar pH, moisture and water activity, the Control cheese product had much lower meltability than the Riddet cheese product.

The sensory properties of the two plant-based cheese products were assessed by a panel of testers (8 people). The results are shown in Table 11.

TABLE 11
Sensory analysis

| | | Mouthfeel (flavour |
|---|---|---|
| Samples | Physical texture | and taste) |
| Riddet cheese | Well mouldable, semi-hard/ | Smoother, creamier, |
| product | hard, sliceable, flexible, | meltable in mouth, soft, |
| | not crumbly/not brittle | creamy, cheesy |
| Control | Mouldable, semi-hard/hard, | Dry, gritty, particulate, |
| cheese | Brittle texture, not flexible | bland flavour, not much |
| product | | cheese flavour |

The Riddet cheese product had the best texture and mouthfeel. This suggests that the extrusion step used to hydrate, coagulate and texturize the protein ingredients provide a better texture and mouthfeel.

### Example 10: Texture Analysis, Rheology, Meltability and Sensory Analysis of Riddet Cheese Product (Melting, Semi-Hard, Sliced) Compared with Commercial Vegan and Dairy Sliced Cheeses

### Methods:

A plant-based cheese product of the invention was prepared in accordance with Example 7 and compared with the following commercial cheeses:
1. Vegan-Veesey cheese slice (<1% protein)
2. Vegan-Green Vie® cheese slice (0.3% protein)
3. Vegan-Savour® cashew cheese (14% protein)
4. Dairy-Anchor® cheddar processed cheese slice (18% protein)
5. Dairy-Anchor® tasty processed cheese slice (18% protein)
6. Dairy-Amul® processed cheese (20% protein)

The texture analysis, rheology, meltability and sensory analysis were carried out in accordance with the procedures set out in Example 9.

### Results:

The results of the texture analysis are shown in Table 12.

TABLE 12
Textural analysis data for cheese products

| Sample | | Hardness (g) | Springiness | Cohesiveness | Gumminess | Chewiness |
|---|---|---|---|---|---|---|
| Riddet cheese product | | 1294 ± 147 | 0.742 ± 0.024 | 0.554 ± 0.014 | 716 ± 74 | 532 ± 68 |
| Vegan | Veesey ® | 4280 ± 253 | 0.787 ± 0.017 | 0.821 ± 0.005 | 3511 ± 191 | 3083 ± 134 |
| | cheese slice | | | | | |
| | Green Vie ® | 6854 ± 178 | 0.875 ± 0.017 | 0.785 ± 0.012 | 5381 ± 179 | 4709 ± 180 |
| | cheese slice | | | | | |
| | Savour ® | 247 ± 25 | 0.480 ± 0.027 | 0.426 ± 0.025 | 105 ± 5 | 50.5 ± 5.5 |
| | cashew cheese | | | | | |
| Dairy | Anchor ® | 1123 ± 38 | 0.900 ± 0.025 | 0.806 ± 0.001 | 905 ± 30 | 813 ± 8 |
| | cheddar | | | | | |
| | processed | | | | | |
| | cheese slice | | | | | |
| | Anchor ® | 1046 ± 53 | 0.883 ± 0.035 | 0.807 ± 0.012 | 844 ± 38 | 745 ± 23 |
| | tasty processed | | | | | |
| | cheese slice | | | | | |
| | Amul ® | 2180 ± 99 | 0.860 ± 0.006 | 0.752 ± 0.014 | 1638 ± 51 | 1410 ± 48 |
| | processed | | | | | |
| | cheese | | | | | |

In terms of texture characteristics, the Riddet cheese product has a similar hardness, gumminess and chewiness to both Anchor® dairy cheeses and is closer in texture to dairy cheeses overall. The vegan cheeses (apart from the Savour® nut-based high protein cashew cheese) had a significantly higher hardness than the dairy cheeses and the Riddet cheese product. The vegan cheeses tested had a similar springiness and cohesiveness to that of dairy cheeses.

The plant-based cheese product of the invention is lower in hardness, gumminess, and chewiness than the commercial vegan cheeses tested. This indicates that the process of the invention creates a plant-based cheese product that is closer in texture to dairy cheeses (slices) compared to the tested vegan cheeses.

This finding is similar to the finding observed in Example 9 where the process of the invention produced a plant-based cheese product with lower hardness, gumminess, and chewiness compared to the product of the control process which didn't include extrusion or use of enzymes. The commercial vegan cheese products tested were produced by a process similar to that of the control process used.

The Savour® semi-soft cashew-based protein cheese is the softest of the cheese products analysed. It has the lowest springiness, cohesiveness, gumminess, and chewiness; more like a cheese with no structure.

The rheology results (see FIG. 2) further supports the texture analysis results. Upon heating from 16-85° C., the Riddet cheese product decreased in strength (lower G′, lower hardness) similarly to the dairy cheeses although the initial drop in G′ was higher for the Riddet cheese product than for the dairy cheeses. The profiles of vegan cheeses (those with low to no protein) were very different to those of the dairy cheeses (18-20% protein). The cashew-based high protein nut-based cheese behaved more like a non-meltable cheese in that it showed no difference in G′ with heating, indicating no change in softness/meltability/structure upon heating. Overall the Riddet cheese product was closer to dairy cheese in rheological profile than the other plant-based cheese products.

The meltability and other characteristics of the various cheese products were compared, as set out in Table 13.

TABLE 13
Meltability

| | | | Moisture | Water | |
|---|---|---|---|---|---|
| | | | Content | Activity | Meltability |
| Sample | | pH | (%) | (Aw) | (%) |
| Riddet cheese product | | 5.63 | 55.35 ± 0.42 | 0.965 ± 0.002 | 25.68 ± 0.32 |
| Vegan | Veesey ® vegan | 4.2 | 48.41 ± 1.08 | 0.975 ± 0.000 | 0.00 |
| | cheese | | | | |
| | Green Vie ® vegan | 4.61 | 49.82 ± 0.37 | 0.971 ± 0.006 | 4.49 ± 0.40 |
| | cheese | | | | |
| | Savour ® Cashew | 4.34 | 40.51 ± 0.14 | 0.960 ± 0.000 | 0.00 |
| | Vegan cheese | | | | |
| Dairy | Anchor ® dairy | 5.62 | 48.04 ± 0.06 | 0.960 ± 0.001 | 86.95 ± 0.97 |
| | cheddar processed | | | | |
| | cheese slice | | | | |
| | Anchor ® dairy | 5.47 | 47.61 ± 0.03 | 0.927 ± 0.003 | 84.38 ± 0.42 |
| | tasty cheese slice | | | | |
| | Amul ® processed | 5.62 | 45.29 ± 0.30 | 0.956 ± 0.004 | 18.95 ± 0.52 |
| | dairy cheese | | | | |

In general, the vegan cheeses were found to have both lower pH and lower meltability than both the Riddet cheese product and the dairy cheeses. Water activity remained similar in all the cheeses. The dairy cheeses had higher meltability and Riddet's cheese product had a meltability closer to one of the dairy cheeses, than to the other plant-based vegan cheese products. The Savour® semi-soft high protein cashew-based cheese had zero meltability.

It has to be noted that there are many varieties of cheese available worldwide and the inventors have used the processed cheeses which were available in the New Zealand market at the time of analysis.

The sensory properties of the various cheese products were assessed by a panel of testers (8 people). The results are shown in Table 14.

TABLE 14
Sensory analysis

| Samples | | Texture & sliceability | Mouthfeel (Flavour & taste) |
|---|---|---|---|
| Riddet cheese product | | semi-hard/hard, very | Smoother, creamier, meltable in |
| | | sliceable, very flexible, | mouth, soft, creamy, cheesy, |
| | | no brittleness | slightly bitter |
| Vegan | Veesey ® vegan | brittle, hard and dry | Not melting in mouth, chewy, |
| | cheese slice | | plastic, rubbery, fractures easily, |
| | | | margarine, lingering in mouth, |
| | | | like cooked boiled potato, some |
| | | | creamy cheese flavour |
| | Green vie ® vegan | brittle, hard and dry | Not melting in mouth, chewy, |
| | cheese slice | | plastic, rubbery, fractures easily |
| | | | (not like mature cheddar |
| | | | factures), lingering in mouth, |
| | | | cheddar-like cheese taste |
| | Savour ® Cashew | Very soft and moist, hard to | Soft, mouth coating, gritty, sour, |
| | Vegan cheese | slice and gritty (like fresh | acidic |
| | | ricotta cheese, no rigid | |
| | | structure) | |
| Dairy | Anchor ® dairy | Bouncy, elastic, stretchy | buttery, milky, creamy, lingers in |
| | cheddar processed | slices | the mouth/mouth coating, dairy |
| | cheese slice | | milk, smooth, creamy mouthfeel, |
| | | | cheddar flavour |
| | Anchor ® dairy | Bouncy, elastic, stretchy | Creamy in mouth, mouth |
| | tasty cheese slice | slices | coating, milky flavour, creamy |
| | | | taste |
| | Amul ® processed | Bouncy, hard but sliceable | Mouth coating, thick, creamy, |
| | dairy cheese | and elastic | strong cheesey flavour, milky, |
| | | | creamy, slightly bitter |

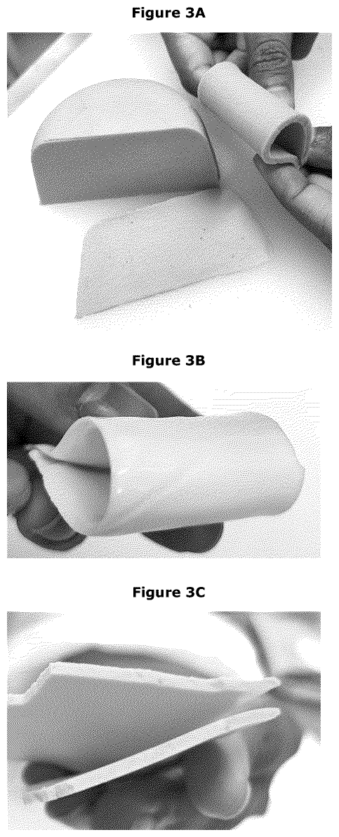

In terms of sensory, dairy cheeses were preferred by everyone due to their milky, creamy, and genuine cheddar flavour. However, the Riddet cheese product was preferred over the other plant-based cheese products because it was creamier, smoother, and had a more meltable mouthfeel with no grittiness. The testers also found the Riddet cheese product to have a texture close to that of dairy cheese slices. In contrast, the vegan high protein cashew cheese was perceived as sourer, softer, moister, and grittier in texture. FIG. 3 shows the texture of the Riddet cheese product (FIG. 3A) compared to Anchor® dairy tasty cheese slice (FIG. 3B) and Veesey® vegan cheese slice (FIG. 3C).

The Riddet cheese product slices (3A) are foldable, flexible and bouncy in texture, similar to the dairy cheese slice (3B). In contrast, the commercial vegan cheese slices (3C) are brittle in texture, not flexible and break easily.

### Example 11: Texture Analysis, Rheology, Meltability and Sensory Analysis of Riddet Cheese Product (Non-Melting) Compared with Commercial Vegan and Dairy Non-Melting Cheeses

### Methods:

A plant-based cheese product of the invention was prepared in accordance with Example 4.

The Riddet cheese product was compared with the following commercial cheeses:
1. Vegan—Green Vie® vegan haloumi, 1.2% protein
2. Dairy—The Waimata Cheese Co® Haloumi, 19% protein
3. Dairy—Gopala® Dairy Paneer, 25.3% protein

The texture analysis, rheology, meltability and sensory analysis were carried out in accordance with the procedures set out in Example 9.

### Results:

The results of the texture analysis are shown in Table 15.

TABLE 15
Textural analysis data for cheese products

| Sample | | Hardness (g) | Springiness | Cohesiveness | Gumminess | Chewiness |
|---|---|---|---|---|---|---|
| Riddet cheese product | | 1393 ± 112 | 0.728 ± 0.026 | 0.622 ± 0.02 | 865 ± 52 | 630 ± 52 |
| Vegan | Green Vie ® | 6854 ± 178 | 0.875 ± 0.017 | 0.785 ± 0.012 | 5381 ± 179 | 4709 ± 180 |
| | vegan haloumi | | | | | |
| Dairy | The Waimata | 2965 ± 355 | 0.926 ± 0.013 | 0.788 ± 0.010 | 2340 ± 305 | 2165 ± 266 |
| | Cheese Co ® | | | | | |
| | Haloumi Cow | | | | | |
| | cheese | | | | | |
| | Gopala ® Dairy | 2299 ± 188 | 0.882 ± 0.051 | 0.756 ± 0.005 | 1738 ± 138 | 1537 ± 200 |
| | Paneer | | | | | |

In terms of texture characteristics, the non-melting Riddet cheese product has low hardness, low gumminess, and chewiness compared to vegan haloumi, dairy haloumi and paneer types of non-melting cheeses. However, its texture characteristics (hardness) were closer to dairy paneer and haloumi than was the vegan haloumi which was much too hard in texture.

It has to be noted that in India there are many versions of non-melting paneer cheese which range in firmness from very soft to hard. The texture of the non-melting Riddet cheese product is expected to be close to those softer versions of dairy paneer cheeses but they were not available commercially in NZ market at the time of testing.

TABLE 16
Other characteristics analysed.

| | | Moisture | Water |
|---|---|---|---|
| | | Content (%) ± | Activity (Aw) ± |
| Sample | pH | standard deviation | standard deviation |
| Non-melting Riddet | 6.53 | 59.41 ± 0.26 | 0.956 ± 0.000 |
| cheese product | | | |
| Green Vie ® vegan | 4.15 | 45.63 ± 0.30 | 0.955 ± 0.003 |
| haloumi | | | |
| The Waimata Cheese | 6.05 | 39.82 ± 1.72 | 0.947 ± 0.003 |
| Co ® Haloumi (dairy) | | | |
| Gopala ® Dairy Paneer | 5.22 | 42.09 ± 0.35 | 0.991 ± 0.001 |

The non-melting Riddet cheese product had a higher pH (close to one of the dairy non-melting cheeses) and higher moisture content compared to the other non-melting cheeses in the market. However, it must be noted that it had a similar, to lower water activity compared to other non-melting cheeses. Low water activity may contribute to higher shelf stability.

The sensory properties of the non-melting cheeses were assessed by a panel of testers (8 people). The results are shown in Table 17.

TABLE 17
Sensory analysis

| | | Mouthfeel (flavour and |
|---|---|---|
| Sample | Texture | taste) |
| Non-melting Riddet | Gritty, softer like soft Indian | Nuttier taste, fresh cheese curds |
| cheese product | kitchen style type of paneer, | like, soft grits, softer texture on |
| | easily breakable, crumbly | cooking similar to paneer. |
| Green Vie ® | Extremely hard texture, | Very chewy in mouth, very |
| vegan haloumi | smooth | salty, tough |
| The Waimata Cheese | Firm, dry, rubbery, smooth | Salty, chewy, dairy taste, tastes |
| Co ® Haloumi | | like fresh cheese curds, tougher |
| (dairy) | | than paneer, springy |
| Dairy Paneer | Smooth, milky, creamy, | Bland, Soft and gritty on cooking, |
| | chewy, like a hard type | looks like fresh cheddar curds, |
| | of paneer, moist | breaks easily on cooking |

Overall, the texture of the non-melting Riddet cheese product was closer to dairy paneer than to other non-melting cheeses.

### 6. REFERENCES

Chavan, R. S. & Jana, A. (2007). Cheese substitutes: An alternative to natural cheese-a review. International Journal of Food Science, Technology and Nutrition, 2, 25-39.
Fox, P. F., Guinee, T. P., Cogan, T. M., & McSweeney, P. L. H. (2017a). Fundamentals of cheese science (2nd ed). New York; Springer 589-628 (Chapter 17).
Guinee, T. P. (2016). Protein in cheese and cheese products: Structure-function relationships. In P. L. H. McSweeney and J. A. O'Mahony (Eds.). Advanced dairy chemistry. Vol 1B: Proteins: Applied aspects (pp. 347-416). New York: Springer.
Masotti, F., Cattaneo, S., Stuknyté, M., & De Noni, I. (2018). Status and developments in analogue cheese formulations and functionalities. Trends in Food Science & Technology, 74, 158-169.

1. A method for producing a plant-based cheese product comprising about 5 wt % to about 40 wt % protein, the method comprising:
(a) providing a composition comprising a source of plant protein and up to about 10 wt % lipid, relative to the source of plant protein;
wherein the source of plant protein comprises:
(i) at least about 5 wt % pea and/or soy protein, and
(ii) at least about 40 wt % total protein;
(b) subjecting the composition to high moisture extrusion to form a semi-solid, texturized mass;
(c) shredding the extruded, texturized semi-solid mass to provide a granular material;
(d) mixing the granular material with lipid and incubating the granular material with one or more protease or protein cross-linking enzymes;
(e) treating the mixture formed in step (d) to inactivate the enzymes; and
(f) cooling the mixture formed in step (e) to provide the plant-based cheese product.

2. The method of claim 1, wherein the source of the plant protein comprises at least about 6, 7, 8, 9 or 10 wt % pea and/or soy protein.

3. The method of claim 1, wherein the source of the plant protein comprises at least about 42, 44, 46, 68 or 50 wt % protein.

4. The method of claim 3, wherein the plant protein is selected from the group comprising pea protein, fava protein, soy protein, mung bean protein, gluten protein, cashew protein, pumpkin seed protein, potato protein, chickpea protein, lentil protein, rice protein, corn protein, sunflower seed protein, tomato seed protein, pongamia protein, canola protein, peanut protein, almond protein, mushroom protein, quinoa protein, lupin protein, oat protein, amaranth protein, flaxseed protein, chia seed protein, cotton seed protein, buckwheat protein, sorghum protein, barley protein, water cress protein, pennycress protein, hemp seed protein, millet protein, teff protein, spelt protein, alfalfa protein, hazelnut protein, broad bean protein, adzuki bean protein, cannellini protein, grass protein, black bean protein, black gram protein, and mixtures thereof.

5. The method of claim 3, wherein the source of plant protein comprises a plant protein powder or mixture thereof, including one or more plant protein isolates, plant protein concentrates or plant protein flours.

6. The method of claim 3, wherein the source of plant protein comprises a pea protein concentrate or isolate, fava protein concentrate or isolate, soy protein concentrate or isolate, mung bean protein concentrate or isolate, hemp protein concentrate, gluten protein concentrate or isolate, or a mixture thereof.

7. The method of claim 3, wherein the source of plant protein comprises pea protein concentrate, fava protein concentrate, soy protein concentrate, or a mixture thereof, in a ratio of about 50:40:10 pea protein: fava protein: soy protein.

8. The method of claim 1, wherein the composition of step (a) comprises about 0.1 wt % to about 10 wt % lipid, per 100 g protein mix on a dry basis, preferably a vegetable oil or mixture of vegetable oils such as canola or sunflower oil.

9. The method of claim 1, wherein the granular material produced in step (c) is mixed with about 5, 7.5, 10, 12.5, 15, 20, or 30 to about 40 wt % lipid, relative to the weight of final product.

10. The method of claim 9, wherein the lipid is selected from the group comprising canola oil, sunflower oil, safflower oil, soybean oil, avocado oil, olive oil, corn oil, flaxseed oil, almond oil, coconut oil, margarine, tucuma fruit butter, hydrogenated oils, non-hydrogenated hard oils, peanut oil, pecan oil, cottonseed oil, algal oil, palm oil, palm olein, palm kernel oil, rice bran oil, wheat germ oil, evening primrose oil, sesame oil, butteroil, cocoa butter, grape seed oil, rapeseed oil, mustard oil, hazelnut oil, brazil nut oil, linseed oil, acai palm oil, passion fruit oil, walnut oil, shea butter, shea stearin, shea olein, palm kernel stearin, palm kernel olein and mixtures thereof, preferably canola oil, rice bran oil, coconut oil, palm oil, margarine, or sunflower oil.

11. The method of claim 1, wherein the granular material is incubated with a microbial protease (preferably a fermentation product of Bacillus sp. or Aspergillus sp. protease) or a protein cross-linking enzyme (preferably a transglutaminase or oxidoreductases such as tyrosinase, laccase, peroxidase, lysyl oxidase/amine oxidase or genipin).

12. The method of claim 1, wherein the incubation mixture is heated to about 80 to about 100° C. for 5 minutes (preferably about 95° C. for 5 min) to inactivate the enzymes or the pH of the incubation mixture is lowered to inactivate the enzymes.

13-14. (canceled)

15. The method of claim 1, wherein lactic acid is added to the granular material in step (d) after enzyme incubation and before enzyme inactivation.

16. A plant-based cheese product comprising about 5 wt % to about 40 wt % protein, preferably about 7, 8, 9, 10, 11, 12 wt % to about 35 wt % protein.

17. The plant-based cheese product of claim 16, which is a melting cheese product.

18. The plant-based cheese product of claim 16, with a meltability, measured using the Schreiber test, of about 10 to about 40%.

19. The plant-based cheese product of claim 16, which comprises about 15 to about 33 wt % protein.

20. The plant-based cheese product of claim 16, which is a non-melting cheese product.

21. The plant-based cheese product of claim 16, which comprises about 18 to about 25 wt % protein.

22. The plant-based cheese product of claim 16, comprising pea protein concentrate, fava protein concentrate and soy protein concentrate, in a ratio of about 50:40:10 pea protein:fava protein:soy protein.
